(19) United States
(12) Patent Application Publication
(10) Pub. No.: US 2012/0299414 A1
(43) Pub. Date: Nov. 29, 2012

(54) TJ POWER

(76) Inventor: Thomas R. Laita, Burnt River (CA)

(21) Appl. No.: 13/385,773

(22) Filed: Mar. 7, 2012

Related U.S. Application Data
(60) Provisional application No. 61/464,903, filed on Mar. 11, 2011.

(51) Int. Cl. H02K 47/04; H02K 7/02; H02K 53/00

(52) U.S. Cl. 310/74; 310/113; 74/DIG. 9

(57) ABSTRACT

TJ POWER is a process that follows the guideline mechanical energy is equal to the primary driving energy plus the secondary energy. The primary driving energy must be able to supply enough torque to drive the mechanical energy at its full output and the secondary driving energy must be able to drive the primary driving energy. This is accomplished by the use of weight, rpm's and the size of connectors to adjust the torque.

### GENERAL CHARACTER

This invention involves a process which uses rpm's, weight and the diameter of connectors to regulate the torque that is required to increase the efficiency of generating units and/or decrease harmful emissions.

### NATURE OF INVENTION

Most generator ends use a stator, armature, magnets, copper wires and rotation to generate power. In a conventional gas generator, the motor turns the armature inside the stator and the magnets create an electro-magnetic field which becomes stronger as the power increases. In TJ POWER, it uses a flywheels stored energy to overpower the magnetic field. Since the flywheel is supplying all the torque to drive the generator end, a secondary driving energy can be used to drive the flywheel. With large generating unit that are using water, burning fossil fuels or uranium to make steam to generate power, these can be replaced by the process of using rpm's, weight and the diameter of connectors to generate the power. This process can be used with existing systems reduce the power of the steam or water that is required to turn the turbines thus reducing their emissions or using less water.

### INVENTIVE IDEA

During my research into power generation, I noticed how much the use of torque played a part, so I had to do my research on how to get the torque needed to run the generating unit instead of a motor. I started by using the formula Me=Pe+Ke whereas, Me is mechanical energy, Pe is potential energy and Ke is kinetic energy. I had a 2000 watt generator end and the manufacturer said it took a 4 hp (horse power) to run it. I also had a 110 amp alternator, which when I asked around at repair shops, was told it would need at least a 3 hp (horse power) to produce the 110 amps (over 1500 watts). I decided on using the car alternator connected to a dead battery due to it's size. I tried using a ¾ hp (horse power) motor to start the alternator, but as soon as I flashed the field (this energizes the alternator so it will start to produce the power), the alternator stopped. The electro-magnetic force was too strong for the ¾ hp motor. I tried different ratio of sprockets and gears to no avail, the electro-magnetic field was still too strong. This is when I thought of installing a flywheel to produce the torque through kinetic energy to drive the alternator and it worked perfectly. After watching it run for awhile, I came up with a guideline that will work on most generating units, I called TJ POWER, it is Me=PDe+SDe whereas, Me is mechanical energy, PDe is primary driving energy (flywheel) and SDe is secondary driving energy. When you are using this guideline, the flywheel's stored energy must be able to produce enough kinetic energy to operate the generating unit at full power. To figure out the kinetic energy required, use 1000 watts equals 72 in/lbs of torque (place weight on the outside diameter of flywheel for larger generating units.), this is the minimum amount of kinetic energy required to run the generator at full capacity. The flywheel can be any shape or size, but it must be able to produce the proper kinetic energy for the generating unit. Once you have the flywheel connected to the generating unit, the secondary driving energy that is going to be used can be connected and it must be able to turn the flywheel at the proper speed. By changing the diameter sizes of the connections or by slowing or increasing rpm's speed, you can adjust the amount of torque required by the secondary driving energy to accomplish this. If you apply this guideline to the 2000 watt generator end, the flywheel would have to produce at least 144 in/lbs of torque and the secondary driving energy used must be able to supply enough torque to turn the flywheel. When using this process on large generating units, the secondary driving unit must gradually build up the rpm's on the flywheel. An example, is using a 240 volt ac, 3 phase motor connected to a VFD that will change 120 volt ac, single phase power to 240 volt ac and 3 phase power and the rpm's can be adjusted.

### FULL DESCRIPTION

Using the block drawing in the abstract to show how the process works following the guidelines. First, the alternator 6 is the mechanical energy, second the flywheel 5 is the primary driving energy, third the ¾ electric motor 3 is the secondary driving energy. The alternator 6 will need the spin at over 2200 rpm's to produce the 110 amps @ over 14 volts dc. Since the alternator 6 will produce around 1500 watts, the flywheel 5 must be able to produce at least 108 in/lb of torque. The ¾ hp motor 3 is connected to a 15-1 speed reducer 4 to build up the torque. In this case, the ¾ hp motor 3 produces 27 in/lbs of torque @ 1750 rpm's, so when connected to the input shaft of the speed reducer 4, the output shaft will produce 405 in/lbs of torque @ around 116 rpm's which strong enough to spin the flywheel 5. Now to connect everything to get to the working rpm's of the alternator 6. The use of sprocket and roller chains are being used to cut down on the friction. On the speed reducers 4 output shaft there is a 60 tooth sprocket which is connected to a 12 tooth sprocket on the shaft of the flywheel 5 to create 580 rpm's. There is another sprocket on the shaft of the flywheel 5 that is connected to the alternator 6. The sprocket on the shaft of the flywheel 5 has 60 teeth and the sprorket on the generating unit 6 has 14 making the speed of the alternator 6 over 2400 rpm's. So the final product is a ¾ hp motor 3 which uses around 850 watts running a an alternator 6 which produces around 1500 watts of power and in this case, since we are using a car alternator 6 which produces dc voltage this process will increase the efficiency of charging a battery.

### DESCRIPTION OF DRAWING

FIG. 1, shows a block drawing of the guideline for TJ POWER.

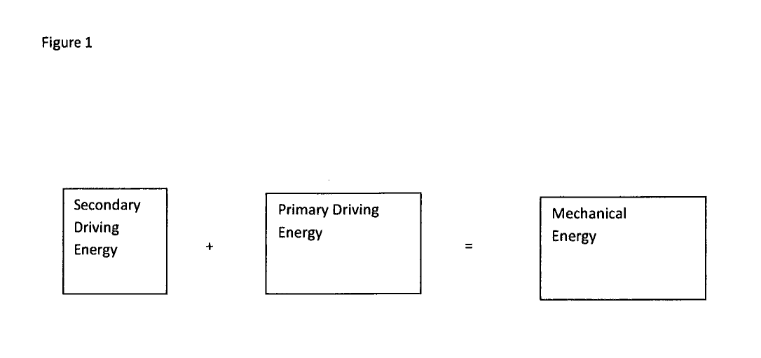

FIG. 2, it shows a block drawing of a 110 amp dc alternator 6 with a 14 tooth sprocket on its shaft which is connected by a roller chain to a shaft with a 60 tooth sprocket and a flywheel (which can produce over 108 in/lbs of torque) and a 12 tooth sprocket 5. This 12 tooth sprocket is connected by a roller chain to a 60 tooth sprocket on a 15-1 ratio speed reducer 4 and then the speed reducer 4 is attached to the ¾ hp motor 3. The reason for the speed reducer 4 is to build up the torque of the motor 3 to turn the shaft with the flywheel 5 which needs more torque at the start. The sprockets are being used to increase the speed so the alternator 6 will turn at the proper speed (the diameter of the sprockets also help with the torque). This has to be done because the speed reducer's 4 manufacturer says the input speed should be 1750 rpm's bringing the output speed to 115 rpm's and the alternator 6 works at over 2200 rpm's to produce it's 110 amps over 12 volts DC. So TJ POWER the process is, build up the torque of the electric motor 3, then using different diameter of sprockets 4, 5 to build back-up the rpm's and again to adjust the torque to turn the flywheel 5. Calculate the amount of energy that is required by the flywheel 5 to get the generating unit 6 to produce full power and use connectors on the shaft of the flywheel 5 and generating unit 6 to run it at the proper rpm's. To help with the torque, place a larger connector on the shaft or the generating unit 6 to apply more torque.

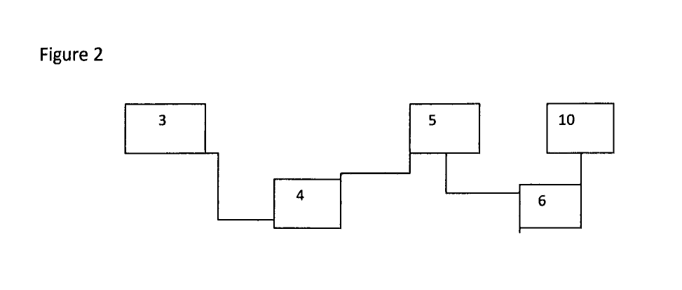

FIG. 3, it shows a block drawing of FIG. 2 (with a few additions) in which uses an alternator 6 as a battery charger which can charge a battery in minutes not hours using 110 volt ac power 1. Added are a switch 2 which turns the ¾ hp motor 3 on and off, another switch 8 which connects the alternator 6 to a 6 volt dc battery 7 to flash the field of the alternator 6, a battery 9 to be charged and a ground 10 connected to the alternator 6.

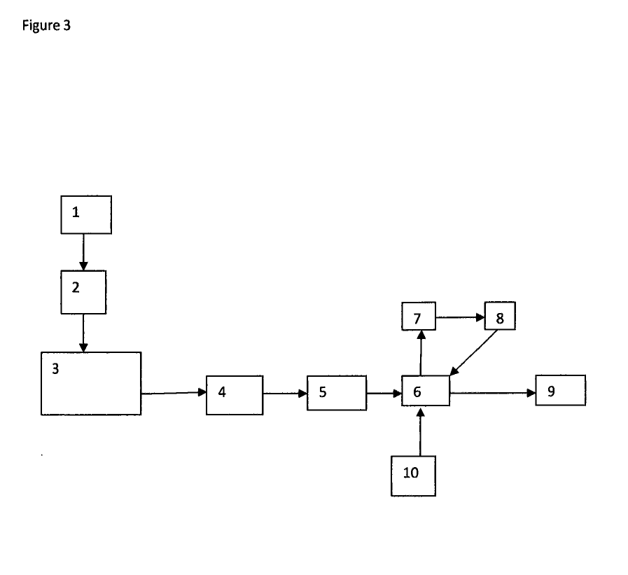

FIG. 4, it shows an illustration of a flywheel 5 which could be used on larger generating units. When using this type of flywheel 5 or any other type or shape flywheel 5, keep the weight on the outside diameter 11. By doing so, you will increase the torque on the shaft through the bore hole 12 and make the calculation of torque required easier.

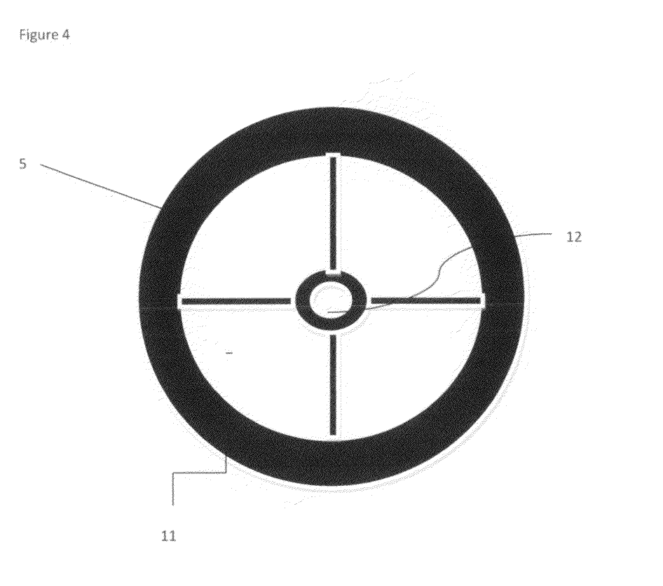

### PRIOR ART

Back in 2003, I filed for a patent in Canada and was given a filing #2,450,028. After building a prototype, I discovered it wouldn't produce maximum power so I let it become abandon. A few years ago I noticed a U.S. Pat. No. 7,095,126 which uses the same principles of my original patent filed back in 2003. By using my changes it will greatly improve the efficiency of these inventions.

This invention will make power generation more efficient over prior art.

The embodiments of the invention in which an exclusive property or privileged are defined as follows.

1. I claim that this process which changes the distribution of torque will improve the efficiency of power generation and/or reduce harmful emissions.

2. I claim that the use of rpm's, weight and the diameter of connectors to supply the torque to run a generating unit will make the generating unit more efficient as in claim 1.

3. I claim a smaller source of energy can be used to turn the flywheel instead of the generating unit thus improving the efficiency of generating power.

4. I claim that by installing the weight on the outside diameter of the flywheel, you will achieve claim 1.

5. I claim that by using the process Me=PSe++SDe, whereas Me is mechanical energy, PSe is primary driving energy and SDe is secondary device energy, you will achieve claim 1.

6. I claim this process could be used to charge batteries in minutes.

7. I claim the secondary device can be anything that will supply enough torque to regulate the speed in claims 1 through 5.

8. I claim when larger generating units are used, the use of a variable speed secondary energy is required.

9. I claim this process will produce an excess amount of power for a period of time.

10. I claim this process is not perpetual energy due to the fact that at some point parts will wear out.

11. I claim that in claim 4, that installing weight on the outside diameter of the flywheel makes the calculation of torque easier and production of flywheels uniform to the size of generating unit.

12. I claim this application is related to and claims priority from provisional patent application No. 61/464,903 filed on Mar. 11, 2011, the contents of which are incorporated herein by reference.
